(19) United States
(12) Patent Application Publication
(10) Pub. No.: US 2026/0103902 A1
(43) Pub. Date: Apr. 16, 2026

(54) MATERIAL REFINING UNIT FOR A MATERIAL INSTALLATION SYSTEM

(71) Applicant: Applegate Greenfiber Acquisition, LLC, Charlotte, NC (US)

(72) Inventors: Ernest Scott Haigler, Marshville, NC (US); Todd Arthur Wannemacher, Ottoville, OH (US); Marvin Lee Johnson, Williamston, MI (US)

(21) Appl. No.: 19/358,170

(22) Filed: Oct. 14, 2025

Related U.S. Application Data
(60) Provisional application No. 63/707,087, filed on Oct. 14, 2024.

(51) Int. Cl. E04F 21/10; B05C 19/00

(52) U.S. Cl. CPC E04F 21/10; B05C 19/00

(57) ABSTRACT

A material refining unit for a material installation system includes a housing and a refining assembly arranged within the housing. The housing defines an internal cavity with an inlet and an outlet. The inlet is configured to receive an insulation material having a first density. The refining assembly is configured to refine the insulation material to a second density that is provided to the outlet and includes a stator and a rotor. The stator is fixedly attached to the housing and has a plurality of stator grooves. The rotor is rotatably coupled to the housing and has a plurality of rotor grooves. A gap is defined between the stator and the rotor.

### CROSS REFERENCE TO RELATED APPLICATIONS

This application claims the benefit of priority of U.S. Provisional Patent Application No. 63/707,087, filed on Oct. 14, 2024, the contents of which is hereby incorporated by reference in its entirety.

### TECHNICAL FIELD

The present disclosure relates generally to material installation systems.

### BACKGROUND

Material installation systems generally provide for installation of a material, such as an insulation material, to residential and commercial buildings. Some material installation systems provide for an insulation material to be conveyed to a location via blowing for installation of the refined material at the location.

### BRIEF DESCRIPTION OF THE DRAWINGS

The foregoing and other features and advantages will be apparent from the following, more particular, description of various exemplary embodiments, as illustrated in the accompanying drawings, wherein like reference numbers generally indicate identical, functionally similar, or structurally similar elements.

FIG. 1 illustrates an exemplary material installation system having a material refining unit, according to an embodiment of the present disclosure.

FIG. 2A illustrates an exemplary material refining unit of the material installation system of FIG. 1, isolated from a motor and an electronic controller of the material refining unit.

FIG. 2B is a detail view of the area labeled 2B-2B in FIG. 2A.

FIG. 2C is a top view of the material refining unit of FIG. 2A.

FIG. 2D is a cross-sectional view taken along line 2D-2D in FIG. 2C.

FIG. 3 is an exploded view of the refining assembly of the material refining unit of FIGS. 2A-2D.

FIG. 4A is a top view of a shim of the refining assembly of FIG. 3, isolated from the refining assembly.

FIG. 4B is a side view of the shim of FIG. 4A.

FIG. 5 illustrates an exemplary stator and a first housing portion of a housing of the material refining unit of FIGS. 2A-2D.

FIG. 6 illustrates an exemplary rotor and a second housing portion of the housing of the material refining unit of FIGS. 2A-2D.

FIG. 7A is a front-side view of the stator of FIG. 3, isolated from the material refining unit.

FIG. 7B is a front view of the stator of FIG. 7A.

FIG. 7C is a rear view of the stator of FIG. 7A.

FIG. 7D is a side view of the stator of FIG. 7A.

FIG. 7E is a partial, detail view of the area labeled 7E-7E in FIG. 7D.

FIG. 7F is a cross-sectional view taken along line 7F-7F in FIG. 7B.

FIG. 8A is a front view of the rotor of FIG. 3, isolated from the material refining unit.

FIG. 8B is a rear view of the rotor of FIG. 8A.

FIG. 8C is a side view of the rotor of FIGS. 8A and 8B.

FIG. 8D is an exploded view of the rotor of FIGS. 8A-8C.

FIG. 9A is a top-side view of a mounting base of the rotor of FIGS. 8A-8D, isolated from a rotor plate of the rotor.

FIG. 9B is a side view of the mounting base of FIG. 9A.

FIG. 9C is a top view of the mounting base of FIG. 9A.

FIG. 10A is a front-top-side view of a vane of the rotor of FIGS. 8A-8D, isolated from the rotor plate of the rotor.

FIG. 10B is a side view of the vane of FIG. 10A.

FIG. 10C is a top view of the vane of FIG. 10A.

FIG. 11A is a front-side view of the rotor plate of the rotor of FIGS. 8A-8D.

FIG. 11B is a front view of the rotor plate of FIG. 11A.

FIG. 11C is a side view of the rotor plate of FIGS. 11A and 11B.

FIG. 11D is a partial, cross-sectional view taken along line 11D-11D in FIG. 11B.

FIG. 11E is a partial, cross-sectional view taken along line 11E-11E in FIG. 11B.

FIG. 12 is a schematic view of the material refining unit of the material installation system of FIG. 1.

### DETAILED DESCRIPTION

Features, advantages, and embodiments of the present disclosure are set forth or apparent from a consideration of the following detailed description, drawings, and claims. Moreover, the following detailed description is exemplary and intended to provide further explanation without limiting the scope of the disclosure as claimed.

Various embodiments of the present disclosure are discussed in detail below. While specific embodiments are discussed, this is done for illustration purposes only. A person skilled in the relevant art will recognize that other components and configurations may be used without departing from the present disclosure.

The terms “refine” or “refining,” as used herein with regard to an insulation material, refers to decompression and declumping of the insulation material, e.g., via a component of a material installation system, such that a density of the insulation material is changed from a particular density (e.g., a packaged density or an initial density) to another density (e.g., a final density or an installation density).

As used herein, the terms “first density,” “second density,” “third density,” “initial density,” “intermediate density,” and “final density,” with regard to an insulation material, refer to a particular state or characteristic (e.g., a density) of the insulation material before, during, or after the insulation material undergoes refinement. For example, an insulation material having an initial density may correspond to a particular state of the insulation material prior to being refined (e.g., to an intermediate density) or more refined (e.g., to a final density). As another example, an insulation material having an intermediate density may correspond to a state of the insulation material after being partially refined (e.g., from an initial density) and prior to being more refined (e.g., to a final density). As yet another example, an insulation material having a final density may correspond to a state of the insulation material after being refined (e.g., from an initial density) or further refined (e.g., from an intermediate density). In some examples, an initial density of an insulation material may correspond to a packaged density (e.g., a compressed density of the insulation material as packaged for transport). In some examples, a final density of an insulation material may correspond to an installation density (e.g., a density of the insulation material as installed at a target location) and/or a manufactured density (e.g., a density of the insulation material as manufactured and prior to being compressed to a packaged density). In some examples, a first density of an insulation material may correspond to an initial density or an intermediate density of the insulation material. In some examples, a second density of an insulation material may correspond to an intermediate density or a final density of the insulation material. In some examples, a third density of an insulation material may correspond to an intermediate density or a final density of the insulation material.

As used herein, the terms “first,” “second,” “third,” etc., may be used interchangeably to distinguish one component from another and are not intended to signify location or importance of the individual components.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “coupled,” “fixed,” “attached,” “connected,” and the like, refer to both direct coupling, fixing, attaching, or connecting, as well as indirect coupling, fixing, attaching, or connecting through one or more intermediate components or features, unless otherwise specified herein.

The singular forms “a,” “an,” and “the” include plural references unless the context clearly dictates otherwise.

As used herein, the terms “axial” and “axially” refer to directions and orientations that extend substantially parallel (i.e., parallel to within five degrees) to a longitudinal centerline axis of a particular component. Moreover, the terms “radial” and “radially” refer to directions and orientations that extend substantially perpendicular to the longitudinal centerline axis of the component. In addition, as used herein, the terms “circumferential” and “circumferentially” refer to directions and orientations that extend arcuately about the longitudinal centerline axis of the component.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” “generally,” and “substantially” is not to be limited to the precise value specified. In at least some instances, the approximating language may correspond to the precision of an instrument for measuring the value, or the precision of the methods or the machines for constructing the components and/or the systems or manufacturing the components and/or the systems. For example, the approximating language may refer to being within a one, two, four, ten, fifteen, or twenty percent margin in either individual values, range(s) of values and/or endpoints defining range(s) of values.

Here and throughout the specification and claims, range limitations are combined, and interchanged. Such ranges are identified and include all the sub-ranges contained therein unless context or language indicates otherwise. For example, all ranges disclosed herein are inclusive of the endpoints, and the endpoints are independently combinable with each other.

The present disclosure provides for a material refining unit for material installation systems. The material refining unit can be positioned downstream of a material transportation unit, e.g., a blower and/or agitator, of the material installation system. The material refining unit can sift or “declump” an insulation material from a compressed or packaged condition to an installation condition (i.e., an original manufactured settled density) that maximizes the insulative properties and coverage attributes of the insulation material for application of the insulation material to a target location.

Some widely utilized insulation materials, e.g., compact loose-fill cellulose insulation materials, are manufactured to a particular installation density to ensure compliance with one or more industry regulations or standards, e.g., American Society for Testing and Materials (ASTM) Standard C739. However, once manufactured, cellulose insulation materials are commonly compressed to a packaged density to be packaged into bales in order for more efficient transportation of the cellulose insulation material in bulk. For example, a desired installation density of a compact loose-fill cellulose insulation material can be between about 1.0 pounds per cubic foot (lbs./ft.³) and about 4.0 lbs./ft.³ but is commonly compressed to a package density between about 8.0 lbs./ft.³ and about 12.0 lbs./ft.³. Further, in comparison to fiberglass insulation materials, cellulose insulation materials are denser, which can provide for a higher thermal resistance in a thinner application layer.

Conventional material transportation units of material installation systems commonly include an agitator and a blower. The agitator is located upstream of the blower and is arranged to decompress and break up the bales of insulation material into smaller pieces before being provided to the blower. However, many conventional material transportation units are designed specifically to decompress fiberglass insulation materials, which tend to be significantly less dense than cellulose insulation materials. Particularly, agitators of such convention material transportation units commonly do not adequately decompress certain insulation materials, e.g., cellulose insulation, and can result in clumps of the insulation material to remain as the insulation material is transported via the blower. Furthermore, some blowers of such conventional material transportation units utilize an airlock chamber having an outlet with vanes that receives the insulation material from the agitator and a positive displacement blower to blow the insulation material through the outlet of the airlock chamber to further decompress the insulation material via the vanes. Such blowers with airlock chambers of conventional material transportation units may sufficiently refine fiberglass insulation materials but commonly fail to adequately declump denser cellulose insulation materials. Such clumping of the insulation material, e.g., cellulose insulation materials, can reduce a coverage area per bale of the insulation material over a target area, which can result in reduced performance of the insulation material as well as requiring more bales of insulation material for adequate installation at the target area, increasing time and cost for installation of the insulation material at the target area.

Accordingly, the present disclosure provides for a material refining unit that can provide for installation of an insulation material, e.g., a cellulose insulation material, having a more uniform composition and a density that is substantially equal to a desired installation density of the insulation material, as compared to insulation material installation systems without the benefit of the present disclosure. Particularly, embodiments of the present disclosure can provide a material refining unit of a material installation system that adequately decompresses and declumps certain insulation materials, e.g., a cellulose insulation material, while having an overall weight and size that provides for the material refining unit to be utilized at a worksite of the material installation system. Thus, embodiments of the present disclosure can provide for installation of an insulation material, e.g., a cellulose insulation material, at a location with an increased coverage area per bale of insulation material, as compared to material installation systems without the benefit of the present disclosure. Moreover, embodiments of the present disclosure can permit an insulation material, e.g., a cellulose insulation material, to be compressed to a higher package density, which can reduce costs for transportation of bulk insulation material.

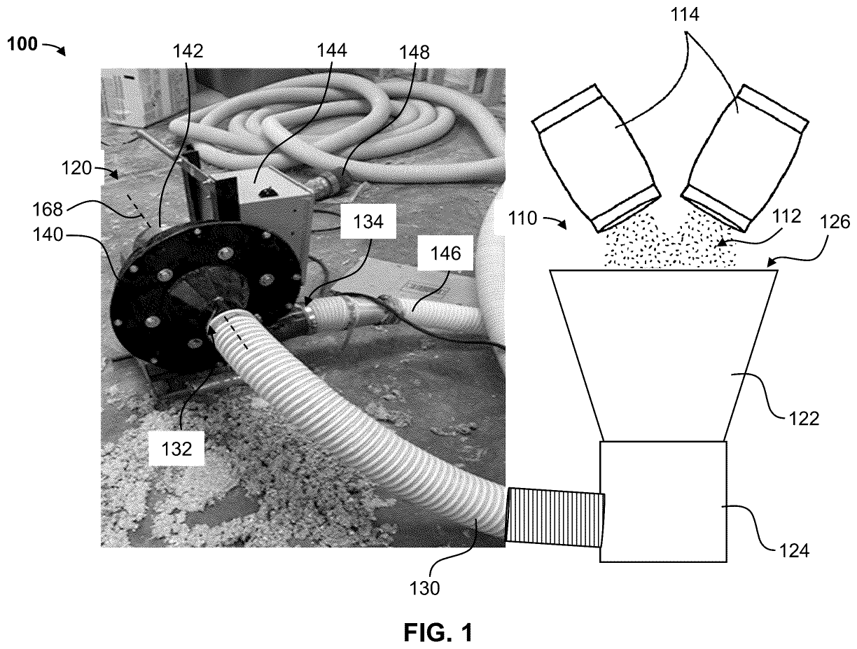

Referring now to the drawings, FIG. 1 illustrates an exemplary material installation system 100 that may incorporate one or more embodiments of the present disclosure. More specifically, in the illustrated embodiment, the material installation system 100 includes a material transportation unit 110 and a material refining unit 120. Generally, the material transportation unit 110 is configured to receive an insulation material 112, e.g., compact loose-fill cellulose insulation, in a packaged or shipped condition (i.e., having a packaged or initial density) and to transport the insulation material 112 along a material flow path to an outlet of the material installation system 100. Further, the material refining unit 120 is configured to decompress or declump the insulation material 112 along the material flow path from the packaged condition to an installation condition (i.e., a final density or the desired installation density).

The material installation system 100, and particularly the material refining unit 120 thereof, can be configured to refine various insulation materials that can comprise various materials and can have varying properties. The insulation material 112 may be selected from the group consisting of fibrous material, granular material, pellet material, and agglomerated material and mixtures thereof. In some embodiments, the insulation material 112 may be inorganic and may be selected from the group consisting of fiberglass, rock wool, pearlite, mineral wool, and asbestos and mixtures thereof. In some embodiments, the insulation material 112 may be organic. In some such embodiments, the insulation material 112 may be a natural material, e.g., cellulosic. In other such embodiments, the insulation material 112 may be an organic fibrous material, e.g., hemp, straw, or wool. In some embodiments, the insulation material 112 may be a non-conductive insulation material. For example, in some such embodiments, the non-conductive insulation material may be one or more of a thermally non-conductive insulation material, an acoustically non-conductive insulation material, or an electrically non-conductive insulation material.

In the illustrated embodiment of FIG. 1, the material transportation unit 110 of the material installation system 100 includes an agitator 122 and a blower 124. The agitator 122 has an agitator opening 126 that receives the insulation material 112 supplied to the agitator opening 126, e.g., contained in bales 114. The agitator 122 is configured to agitate the insulation material 112 before the insulation material 112 is provided to the blower 124. The blower 124 is downstream of the agitator 122 and is configured to provide the insulation material 112 to the material refining unit 120 via a first hose 130 of the material installation system 100. In other words, the material refining unit 120 is a standalone unit that is located downstream of the material transportation unit 110 (i.e., the agitator 122 and the blower 124). In some embodiments, the material refining unit 120 may be integrated with the material transportation unit 110 such that the material refining unit 120 and the material transportation unit 110 are a single integral unit or machine. For example, in some such embodiments, the material refining unit 120 can be retroactively installed with the material transportation unit 110 to form a single integral unit. In some embodiments, the blower 124 can be a separate unit from the agitator 122. For example, in some such embodiments, the blower 124 can be a standalone unit that is connected to, and located downstream of, the agitator 122 via one or more hoses.

The material refining unit 120 receives the insulation material 112 having a first density (e.g., an initial density or an intermediate density) at an inlet 132 thereof from the material transportation unit 110 (e.g., the blower 124) via the first hose 130. In the illustrated embodiment, the material refining unit 120 includes a refining assembly 140, a motor 142, and an electronic controller 144. The refining assembly 140 of the material refining unit 120 is configured to refine the insulation material 112 received at the inlet 132 having the first density and to provide the refined insulation material 112 having a second density (e.g., an intermediate density or a final density) to an outlet 134 of the material refining unit 120. In the illustrated embodiment, the agitator 122 of the material transportation unit 110 may agitate or refine the insulation material 112 from the first density (e.g., an initial density) to a third density (e.g., an intermediate density) that is provided to the inlet 132 of the refining assembly 140 via the blower 124. Thus, in some embodiments, the inlet 132 of the refining assembly 140 can be configured to receive the insulation material 112 having the first density or the third density.

In some embodiments, the first density of the insulation material 112 may be different than one or both of the second density or the third density. For example, in some such embodiments, the second density (e.g., a final density) of the insulation material 112 is less than the first density (e.g., an initial density or an intermediate density). In some embodiments, the third density (e.g., an intermediate density) of the insulation material 112 may be less than the first density (e.g., an initial density) and greater than the second density (e.g., a final density). In some embodiments, the first density may be substantially the same as one or both of the second density or the third density. For example, in some such embodiments, the first density (e.g., an initial density) of the insulation material 112 may be substantially the same as the third density (e.g., an intermediate density).

As will be discussed in more detail below, the motor 142 is operatively connected to the refining assembly 140. In some embodiments, the motor 142 can be an electric motor having a power rating of about 10 horsepower (HP). In some embodiments, the motor 142 can have a power rating in a range of about 2 HP to about 30 HP, in a range of about 5 HP to about 20 HP, or in a range of about 8 HP to about 18 HP.

The electronic controller 144 is electrically connected to the motor 142 and is configured to power and control the motor 142. In some embodiments, the electronic controller 144 can be configured to receive a user input and the electronic controller 144 can be further configured to control the motor 142 based on the received user input. For example, in some embodiments, the electronic controller 144 can include a user interface (not shown) that can be configured to receive a user input corresponding to an output of the motor 142. In some such embodiments, the user interface can be a button, a dial, or a tactile display screen.

In the illustrated embodiment, a second hose 146 of the material installation system 100 is connected to the outlet 134 of the material refining unit 120. In this way, insulation material 112 having the second density (e.g., a final density) that is provided from the outlet 134 of the material refining unit 120 can be installed at a location by a user via an installation nozzle 148 of the second hose 146. In some embodiments, an auxiliary blower may be disposed downstream of the outlet 134 of the material refining unit 120. In some embodiments, the outlet 134 of the material refining unit 120 can be the installation nozzle 148 of the material installation system 100.

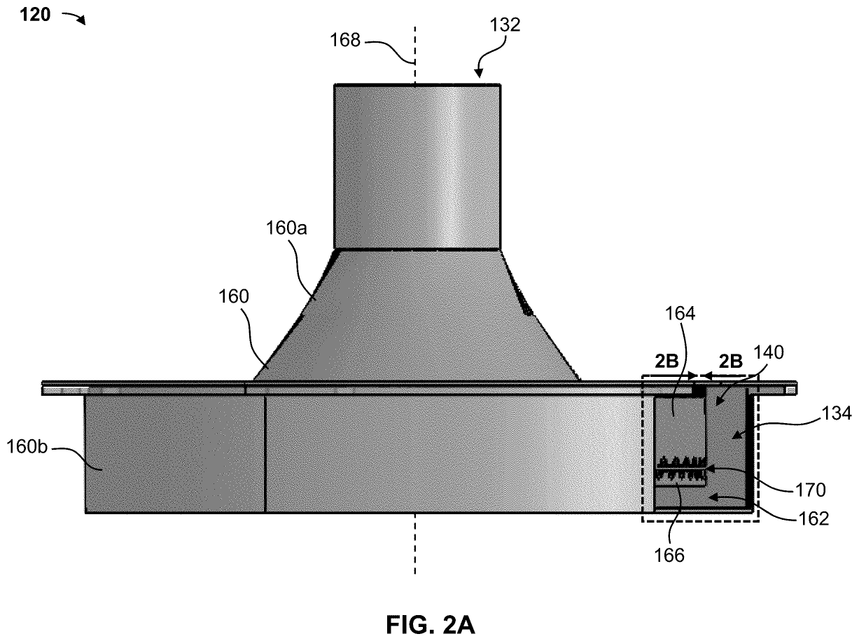

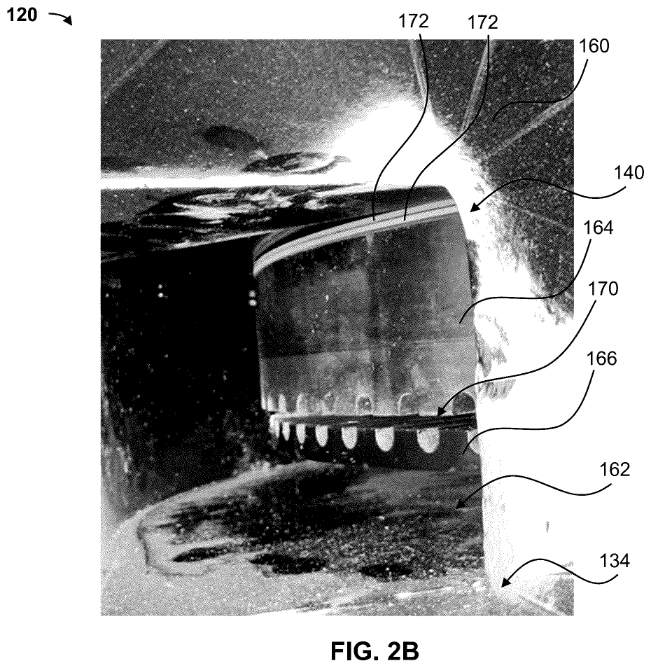

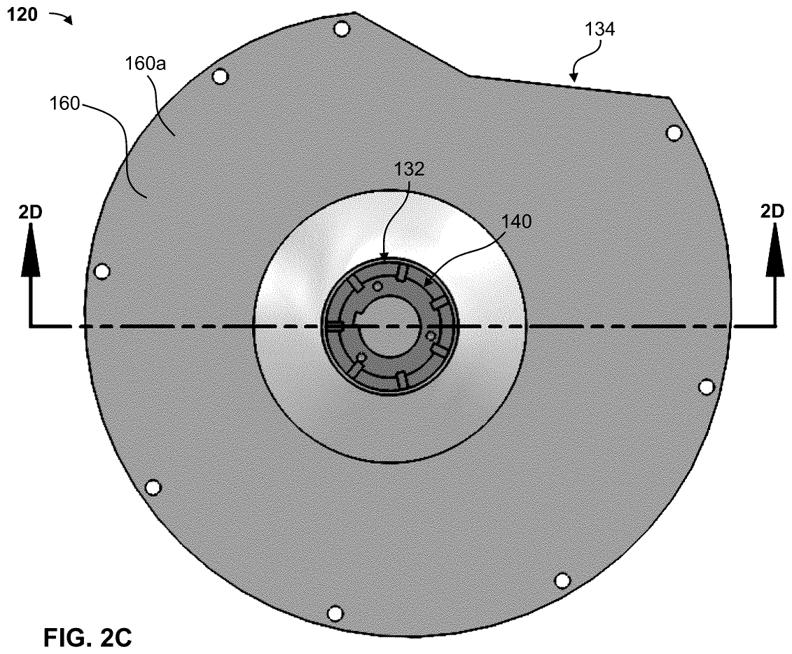

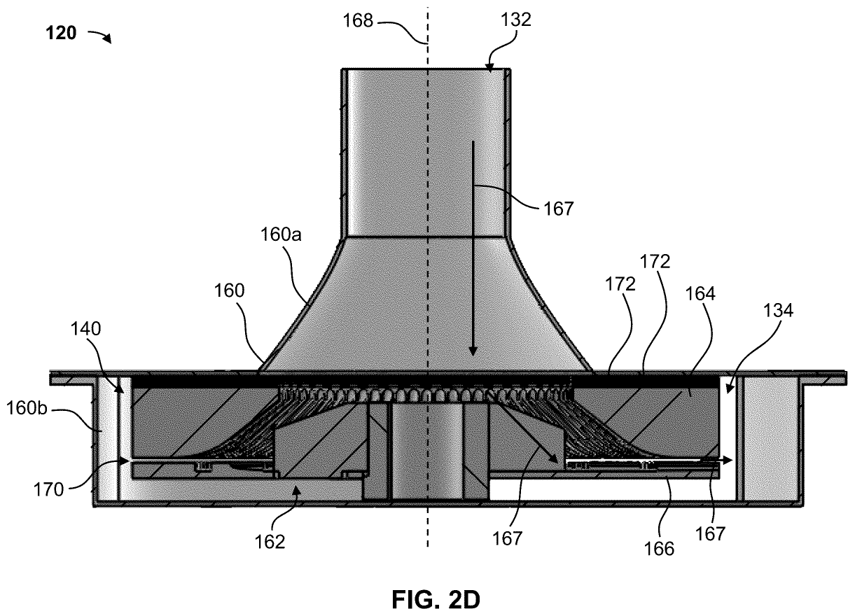

FIGS. 2A-2D illustrate the exemplary material refining unit 120, according to an embodiment of the present disclosure, and shown isolated from the motor 142 and the electronic controller 144 of the material refining unit 120. In the illustrated embodiment, the material refining unit 120 includes a housing 160 that defines an internal cavity 162 and the refining assembly 140 disposed within the internal cavity 162. The refining assembly 140 includes a stator 164 and a rotor 166. The internal cavity 162 is in fluid communication with both the inlet 132 (FIG. 1) and the outlet 134 of the material refining unit 120. In this way, the insulation material 112 received at the inlet 132 enters the internal cavity 162 and is provided to the outlet 134 from the internal cavity 162. In other words, a material refining flow path, as schematically represented by arrows 167 in FIG. 2D, of the insulation material 112 through the internal cavity 162 and the refining assembly 140 is defined by the housing 160 and extends from the inlet 132 and through the internal cavity 162 to the outlet 134.

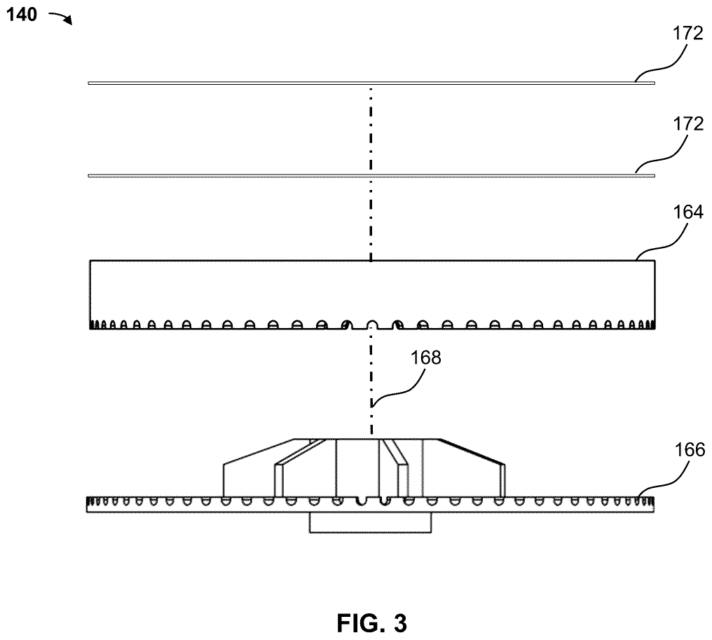

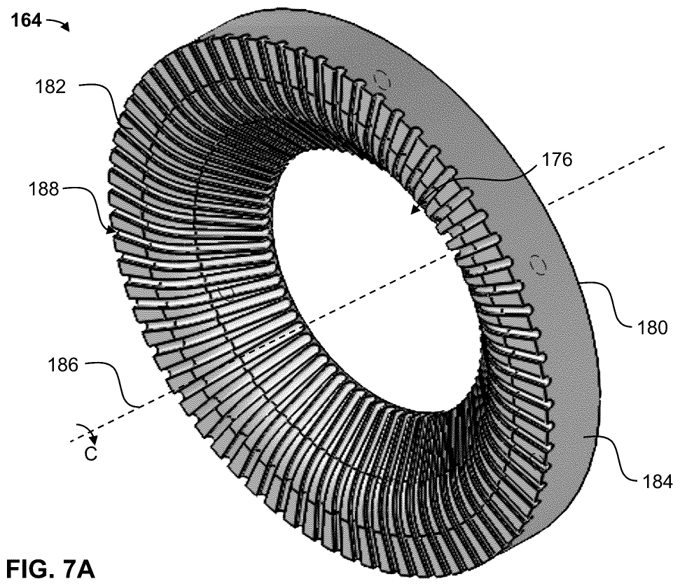

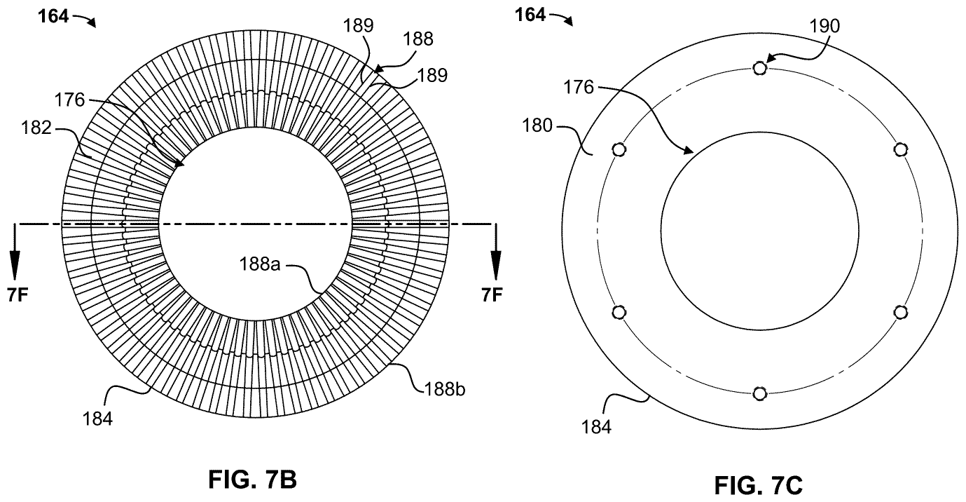

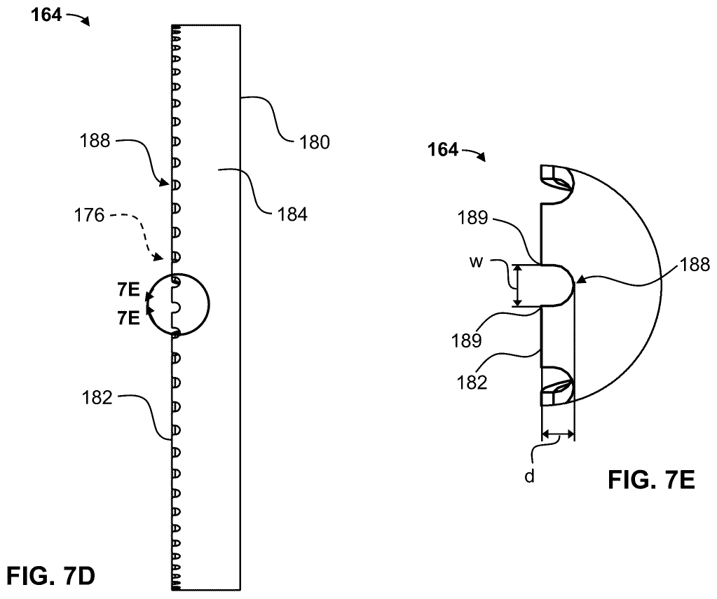

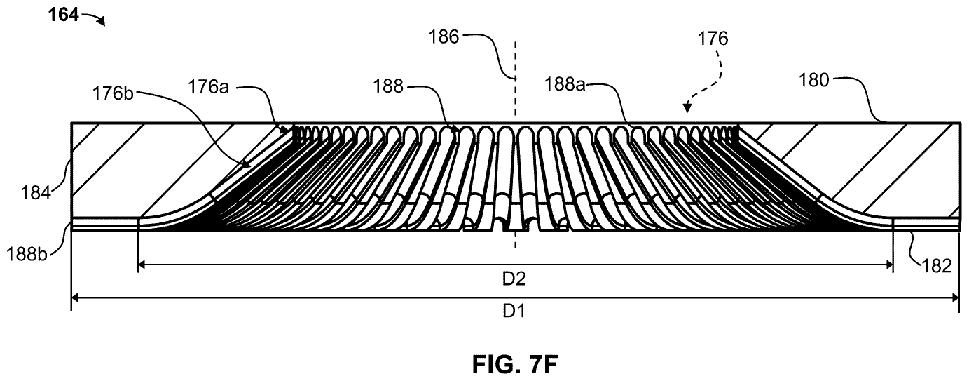

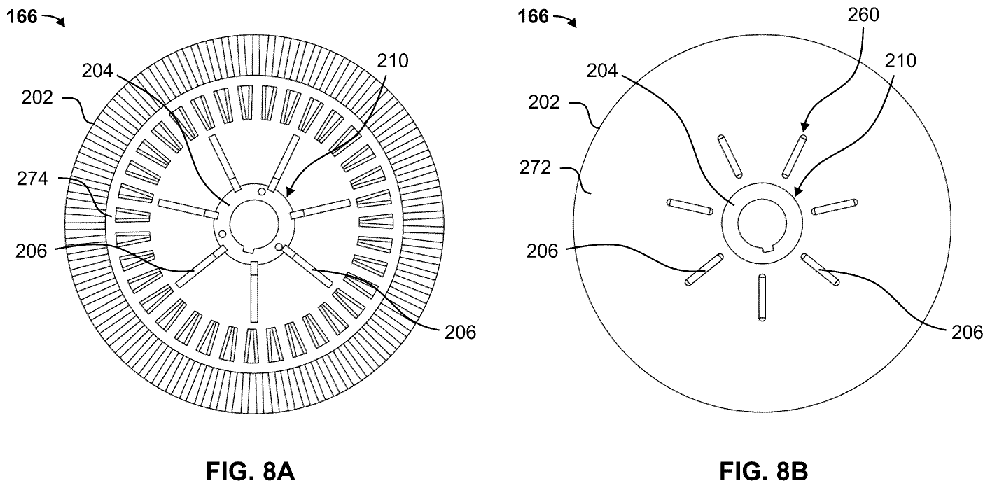

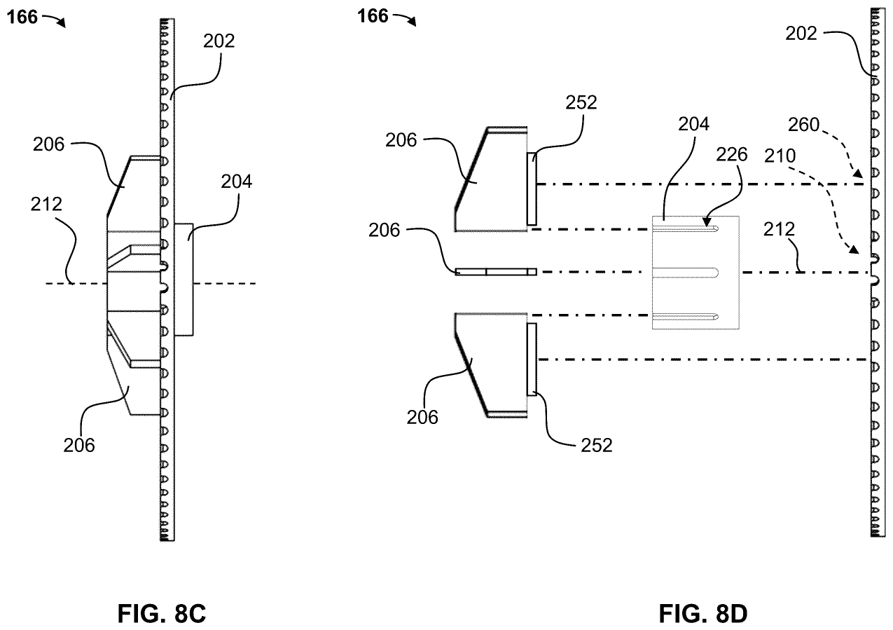

FIG. 3 is an exploded view of the exemplary refining assembly 140 of the material refining unit 120 of FIGS. 2A-2D. As shown in FIG. 3, the refining assembly 140 includes a stator 164 and a rotor 166. Referring again to FIG. 2D, the stator 164 and the rotor 166 are disposed within the internal cavity 162 of the housing 160 and are axially aligned with each other along a rotational axis 168 of the refining assembly 140. More specifically, the stator 164 is fixedly attached to the housing 160 such that the stator 164 remains stationary relative to the housing 160 during operation of the material refining unit 120. The rotor 166 is rotatably attached to the housing 160 and is operatively coupled to the motor 142 (FIG. 1) such that the motor 142 causes the rotor 166 to rotate within the internal cavity 162 about the rotational axis 168 and relative to the stator 164 and to the housing 160. The stator 164 and the rotor 166 will be discussed in more detail below with regard to FIGS. 7A-7F and 8A-8D, respectively.

As shown in FIGS. 2B and 2D, the rotor 166 is disposed at an axial distance from the stator 164 along the rotational axis 168 (FIG. 1) such that a gap 170 is formed between the stator 164 and the rotor 166. The gap 170 is formed in the axial direction such that the stator 164 is spaced from the rotor 166 in the axial direction. In the illustrated embodiment, the inlet 132 and a motor shaft (not shown) of the motor 142 (FIG. 1) of the material refining unit 120 are also aligned with the rotational axis 168. In some embodiments, one or both of the inlet 132 or the motor shaft of the motor 142 may be axially offset from the rotational axis 168.

In the illustrated embodiment, the gap 170 between the stator 164 and the rotor 166 is adjustable by a user via one or more shims 172 (FIGS. 2B, 2D, and 3) that can be included in the refining assembly 140. As shown in FIGS. 2B and 2D, the one or more shims 172 can be disposed between the stator 164 and the housing 160. For example, shims 172 can be added to decrease a size of the gap 170, or shims 172 can be removed to increase the size of the gap 170. A particular size of the gap 170 between the stator 164 and the rotor 166, which is adjustable via the shims 172, affects both a flow rate of the insulation material 112 through the internal cavity 162 (and the refining assembly 140) and a maximum size of individual pieces of the insulation material 112 provided to the outlet 134. More specifically, with an increasing size of the gap 170, both the flow rate through the refining assembly 140 and the maximum size of individual pieces of the insulation material 112 increase (i.e., a coarser size). On the other hand, with a decreasing size of the gap 170, both the flow rate through the refining assembly 140 and the maximum size of individual pieces of the insulation material 112 decrease (i.e., a finer size).

In some embodiments, the gap 170 between the stator 164 and rotor 166, as measured along the rotational axis 168, can be in a range of about 1/64 inch (in.) to about 1 in., in a range of about 1/32 in. to about ¾ in., or in a range of about 1/16 in. to about ½ in. In some embodiments, the gap 170 between the stator 164 and rotor 166, as measured along the rotational axis 168, can be less than ¼ in. In some embodiments, the gap 170 between the stator and the rotor 166 can be fixed.

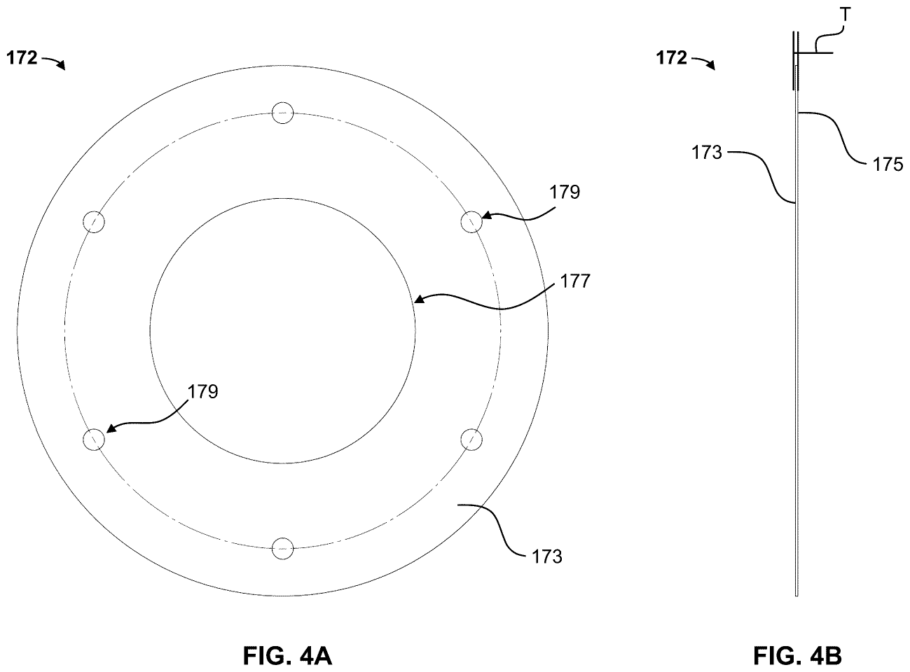

FIGS. 4A and 4B show an exemplary shim 172 of the one or more shims 172 of the refining assembly 140 in greater detail. As shown in FIG. 4A, the shim 172 is annular and has a front side 173, a rear side 175 opposite the front side 173, and a shim opening 177 extending through the front side 173 and the rear side 175. The shim opening 177 is aligned with the rotational axis 168 (FIG. 1). Thus, the shim opening 177 can be adjacent to the inlet 132 of the housing 160 when the shim 172 is arranged between the stator 164 and the housing 160. A plurality of holes 179 extends through the front side 173 and the rear side 175. The plurality of holes 179 is arranged circumferentially about the rotational axis 168 and disposed radially outward relative to the shim opening 177. The plurality of holes 179 can receive a plurality of shim fasteners (not shown) that can removably couple the shim 172 to the stator 164 and thus prevent rotation of the shim 172 during operation of the material refining unit 120.

As shown in FIG. 4B, the shim 172 has an axial thickness T as measured from the front side 173 to the rear side 175. In some embodiments, the axial thickness T of the shim 172 can be in a range of about 0.02 inch to about 0.20 inch, in a range of about 0.04 inch to about 0.10 inch, or in a range of about 0.05 inch to 0.07 inch. In some embodiments, the axial thickness T of the shim 172 can be less than 0.10 inch. In some embodiments, the shim 172 can be formed of a material that is the same as that of the stator 164. In some embodiments, the shim 172 can be formed of a metallic material, e.g., steel. In some embodiments, the rotor 166 can be moveable along the rotational axis 168 such that the gap 170 between the stator 164 and the rotor 166 can be adjustable by a user via movement of the rotor 166. In some embodiments, one or both of the stator 164 or the rotor 166 can be removable and replaced by a user with another stator or another rotor having a different axial thickness such that the gap 170 between the stator 164 and the rotor 166 can be adjustable by the user based on the selected stator or rotor utilized in the refining assembly 140 of the material refining unit 120. In some embodiments, the gap 170 between the stator 164 and the rotor 166 can be fixed.

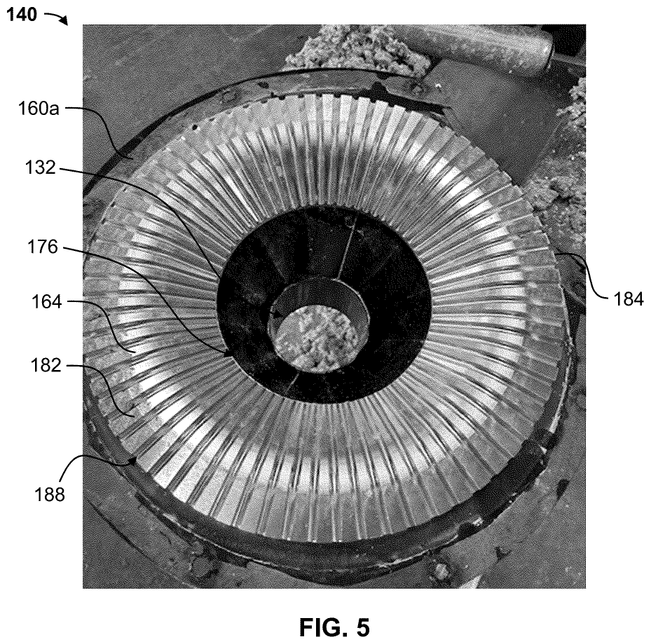

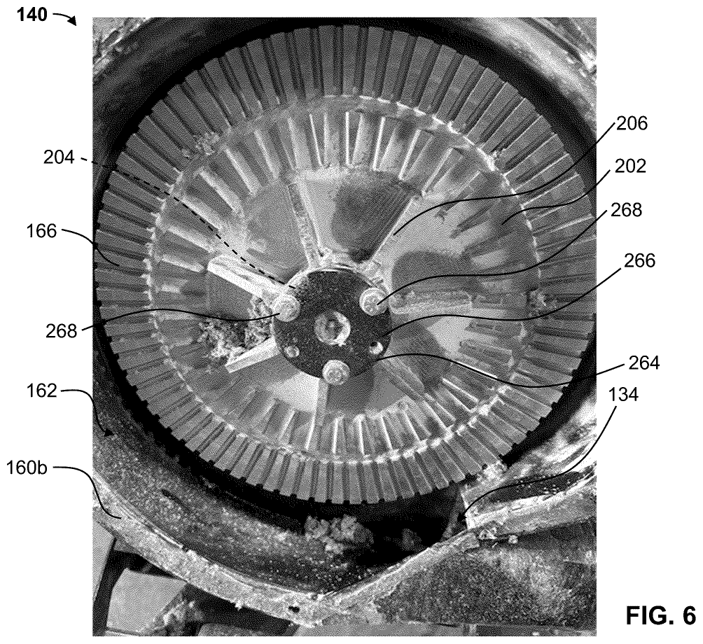

Referring to FIGS. 5 and 6, in the illustrated embodiment, the housing 160 (FIG. 1) of material refining unit 120 includes a first housing portion 160a (FIG. 5) and a second housing portion 160b (FIG. 6) that are removably coupled together to collectively form the housing 160 and the internal cavity 162 (FIG. 2D) defined therewithin. As shown in FIG. 5, the first housing portion 160a defines the inlet 132 of the material refining unit 120 and the stator 164 is fixedly attached to the first housing portion 160a with a stator opening 176 of the stator 164 being adjacent to the inlet 132. As shown in FIG. 6, the second housing portion 160b defines the outlet 134 of the material refining unit 120 and the rotor 166 is rotatably coupled to the second housing portion 160b. In some embodiments, the first housing portion 160a and the second housing portion 160b can be removably coupled to each other via fasteners (e.g., screws or bolts) or via a threaded connection. In some embodiments, the housing 160 can be an integrally formed, single piece of material.

FIGS. 7A-7F show the exemplary stator 164 of the refining assembly 140 (FIG. 3) of the material refining unit 120 (FIG. 1), isolated from the material refining unit 120. In the illustrated embodiment, the stator 164 is annular shaped with a rear surface 180, a front surface 182 opposite the rear surface 180, and an outer surface 184 extending axially along a stator axis 186 (FIG. 7A) from the rear surface 180 to the front surface 182. As shown in FIG. 7F, the stator opening 176 is substantially aligned with the stator axis 186 and has a first portion 176a that extends into the rear surface 180 and a second portion 176b that extends from the first portion 176a to the front surface 182. In the illustrated embodiment, the first portion 176a of the stator opening 176 is generally cylindrical about the stator axis 186 and the second portion 176b of the stator opening 176 is conical and extends radially outward toward the outer surface 184 from the first portion 176a.

A plurality of stator grooves 188 is defined along the front surface 182, the first portion 176a, and the second portion 176b of the stator opening 176 that extend in a circumferential direction C (FIG. 7A). More specifically, the plurality of stator grooves 188 extends radially outward from the first portion 176a of the stator opening 176 and along the second portion 176b of the stator opening 176 and the front surface 182 to the outer surface 184. Referring to FIG. 7B, an inner end 188a of each groove of the plurality of stator grooves 188 extends into stator opening 176 and an outer end 188b, opposite the inner end 188a, extends through the outer surface 184. In the illustrated embodiment, each groove of the plurality of stator grooves 188 is disposed in the circumferential direction C at equal circumferential distances relative to adjacent grooves of the plurality of stator grooves 188. Further, a plurality of stator edges 189 (FIGS. 7B and 7E) is formed by the plurality of stator grooves 188 and disposed along the front surface 182 and the stator opening 176 that can assist in decompressing the insulation material 112 as the insulation material 112 flows in the gap 170 and within the plurality of stator grooves 188.

Referring to FIG. 7F, the second portion 176b of the stator opening 176 has a diameter D2 as defined along the front surface 182, which is less than an overall diameter D1 of the outer surface 184 of the stator 164. As such, at least an outer portion of the plurality of stator grooves 188 that includes the outer end 188b extends along the front surface 182 from the stator opening 176 to the outer surface 184 in a direction that is substantially perpendicular to the stator axis 186. In some embodiments, the diameter D2 of the stator opening 176, as measured along the front surface 182, can be a percentage of the overall diameter D1 of the stator 164, as measured along the outer surface 184, in a range of about 50% to about 95%, in a range of about 60% to about 90%, or in a range of about 70% to about 85%.

Referring to FIG. 7E, each groove of the plurality of stator grooves 188 has a groove width “w” and a groove depth “d,” as measured circumferentially and axially, respectively. In the illustrated embodiment, the groove width w and the groove depth d of each groove of the plurality of stator grooves 188 is substantially uniform along an entire length of each stator groove 188 that extends from the stator opening 176 to the outer surface 184.

Referring to FIG. 7C, the stator 164 can include a plurality of fastener holes 190 that can be utilized to fixedly couple the stator 164 to the first housing portion 160a (FIG. 5) of the housing 160. In some embodiments, the plurality of fastener holes 190 can be threaded holes.

FIGS. 8A-8D show the exemplary rotor 166 of the refining assembly 140 (FIG. 3) of the material refining unit 120 (FIG. 1), isolated from the material refining unit 120. In the illustrated embodiment, the rotor 166 includes a rotor plate 202, a mounting base 204, and a plurality of vanes 206. As shown in FIG. 8D, the mounting base 204 is received within a plate opening 210 of the rotor plate 202 that is axially aligned with a rotor axis 212 (FIGS. 8C and 8D).

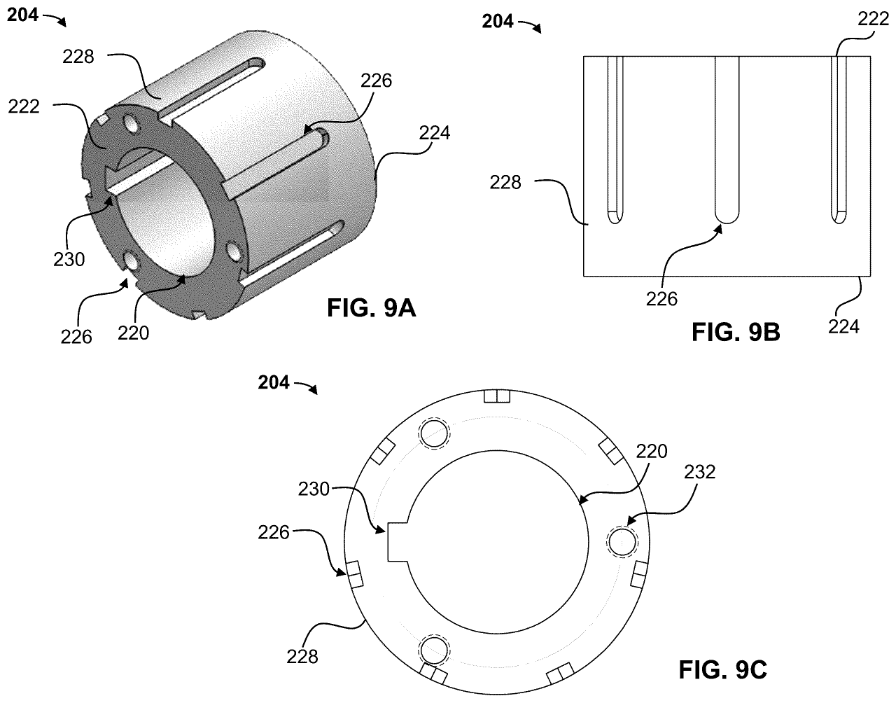

FIGS. 9A-9C show the exemplary mounting base 204 of the rotor 166 (FIGS. 8A-8D) in greater detail. In the illustrated embodiment, the mounting base 204 is generally cylindrical with a base opening 220 extending axially through a first axial end 222 and a second axial end 224, opposite the first axial end 222, of the mounting base 204. A plurality of recesses 226 is defined along a radially outer surface 228 of the mounting base 204. More specifically, the plurality of recesses 226 extends through the first axial end 222 to an axial distance from the second axial end 224. A rotational engagement slot 230 is defined along the base opening 220 that extends axially through the first axial end 222 and the second axial end 224. The rotational engagement slot 230 can be configured to transmit a rotational force from the motor 142 (e.g., a motor shaft thereof) to the rotor 166. Further, a plurality of fastener holes 232 extends through at least the first axial end 222 of the mounting base 204 that can be configured to receive a plurality of fasteners 268 (FIG. 6) to couple the mounting base 204 to the motor 142 (or the motor shaft thereof).

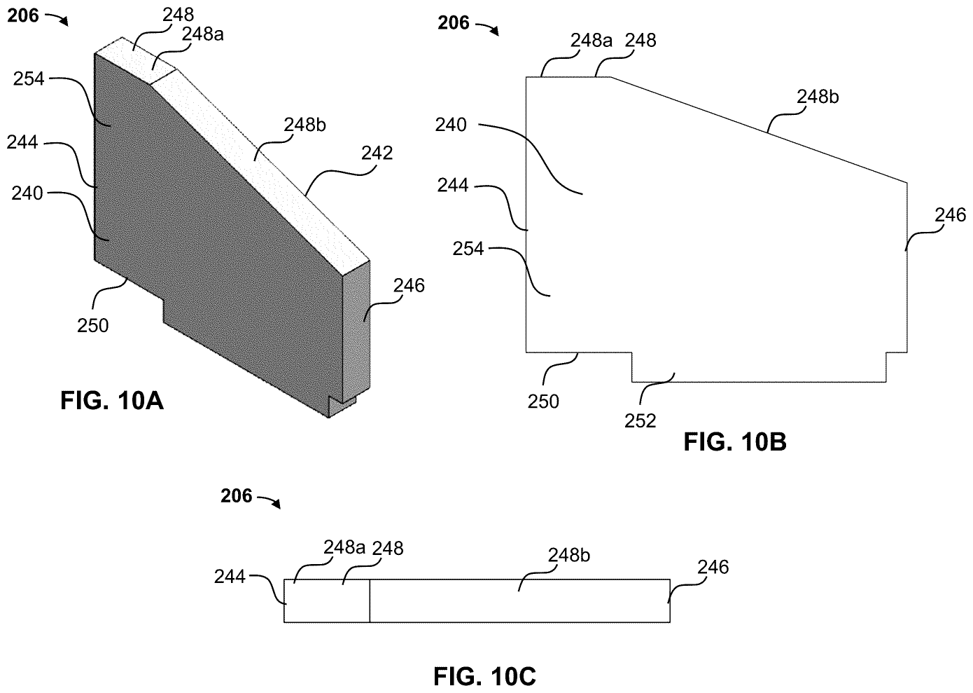

FIGS. 10A-10C show an exemplary vane of the plurality of vanes 206 of the rotor 166 (FIGS. 7A-7D) in greater detail. In the illustrated embodiment, each vane of the plurality of vanes 206 is identical, and thus the description of the exemplary vane below also applies to the other vanes of the plurality of vanes 206. As shown in FIGS. 10A-10C, the vane 206 has a first side 240, a second side 242 opposite the first side 240, an inner end 244, an outer end 246 opposite the inner end 244, a top end 248, and a bottom end 250 opposite the top end 248. A first portion 248a of the top end 248 extends from the inner end 244 and a second portion 248b of the top end 248 slopes downward from the first portion 248a to the outer end 246. A first vane protrusion 252 (FIGS. 10A and 10B) of the vane 206 extends downwardly from the bottom end 250 at a distance from the inner end 244 and from the outer end 246. Further, a second vane protrusion 254 (FIGS. 10A and 10B) of the vane 206 is defined by the inner end 244, the first portion 248a of the top end 248, and an inner portion of the bottom end 250 adjacent to the first vane protrusion 252.

Referring again to FIGS. 8A-8D, the rotor plate 202 includes a plurality of slots 260 that extends through the rotor plate 202 and are circumferentially disposed around the plate opening 210. Each slot of the plurality of slots 260 of the rotor plate 202 is configured to receive the first vane protrusion 252 (FIGS. 10A and 10B) of each vane of the plurality of vanes 206. Further, each recess of the plurality of recesses 226 of the mounting base 204 is configured to receive the second vane protrusion 254 (FIGS. 10A and 10B) of each vane of the plurality of vanes 206. Thus, the plurality of vanes 206 is coupled to both the rotor plate 202 and the mounting base 204 via the plurality of recesses 226 and the plurality of slots 260, respectively.

Referring again to FIG. 6, in the illustrated embodiment, the refining assembly 140 of the material refining unit 120 further includes a rotor mounting cap 264 that is configured to be received within the base opening 220 of the mounting base 204 (indicated with dashed line in FIG. 6) to removably secure the rotor 166 to the motor 142 (FIG. 1). Further, the rotor mounting cap 264 includes a cap flange 266 that engages the first portion 248a of the top end 248 (FIGS. 10A and 10B) of each vane of the plurality of vanes 206. In this way, the rotor mounting cap 264 also removably secures the plurality of vanes 206 to the rotor plate 202 and the mounting base 204. In the illustrated embodiment, the rotor mounting cap 264 is removably secured to the mounting base 204 via a plurality of fasteners 268. In some embodiments, the rotor mounting cap 264 can also include a cap protrusion (not shown) that can be configured to engage the rotational engagement slot 230 (FIGS. 9A and 9C) of the mounting base 204.

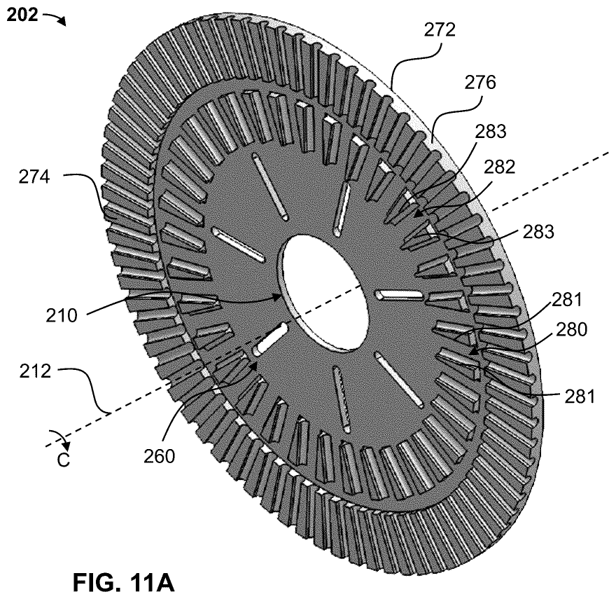

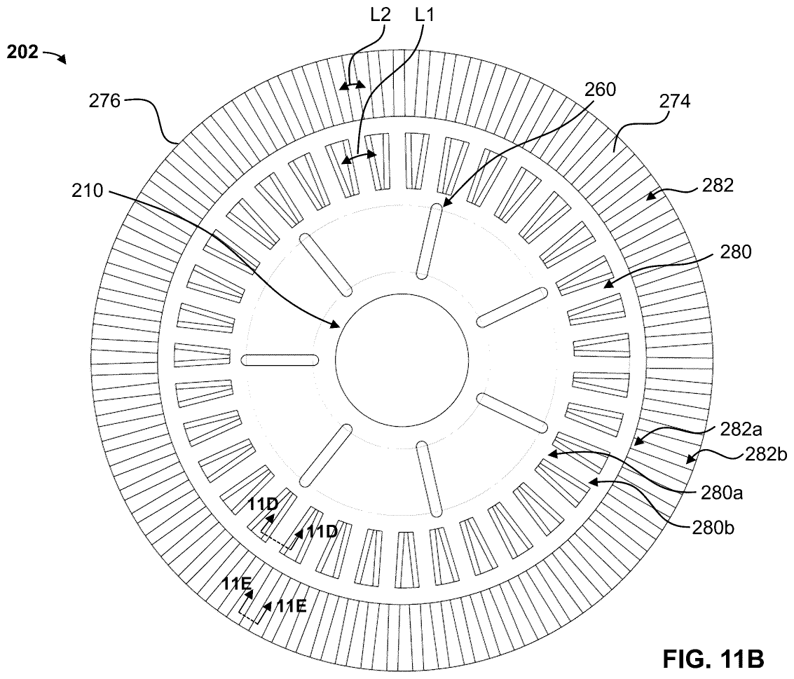

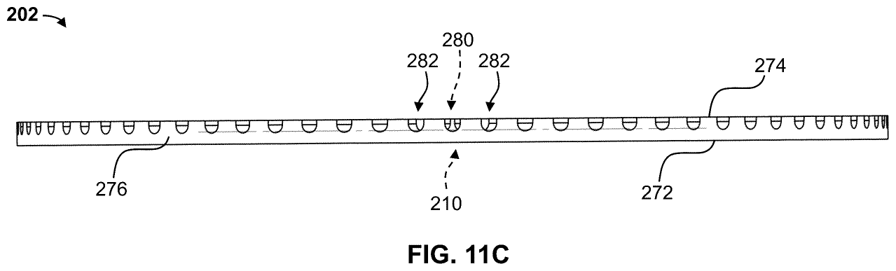

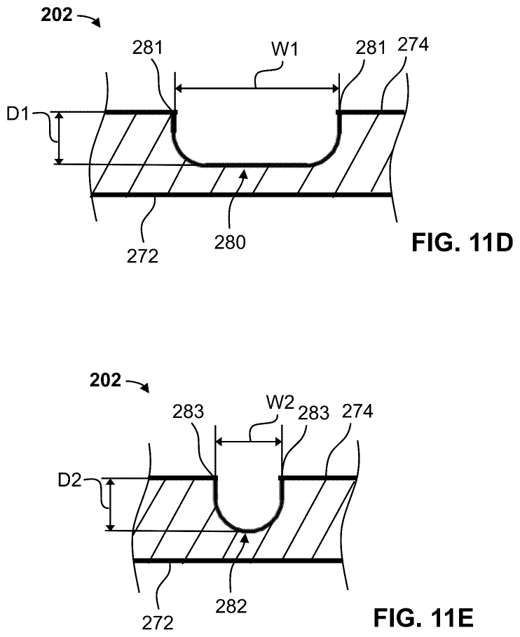

FIGS. 11A-11E show the exemplary rotor plate 202 of the rotor 166 (FIGS. 8A-8D) isolated from the rotor 166. In the illustrated embodiment, the rotor plate 202 is annular shaped with a rear surface 272, a front surface 274 opposite the rear surface 272, and an outer surface 276 extending axially along the rotor axis 212 from the rear surface 272 to the front surface 274.

A plurality of inner rotor grooves 280 and a plurality of outer rotor grooves 282 are defined along the front surface 274 of the rotor plate 202 and that extend in the circumferential direction C (FIG. 11A). More specifically the plurality of inner rotor grooves 280 is radially outward from the plurality of slots 260 that is radially adjacent to the plate opening 210, and the plurality of outer rotor grooves 282 is radially outward from the plurality of inner rotor grooves 280 and extend through the outer surface 276.

As shown in FIG. 11B, the plurality of inner rotor grooves 280 tapers in the circumferential direction C as the plurality of inner rotor grooves 280 extends radially outward such that an inner end 280a of each inner rotor groove of the plurality of inner rotor grooves 280 has a width (in the circumferential direction C) that is greater than that at an outer end 280b thereof. Similarly, the plurality of outer rotor grooves 282 tapers in the circumferential direction C as the plurality of outer rotor grooves 282 extends radially outward such that an inner end 282a of each outer rotor groove of the plurality of outer rotor grooves 282 has a width (in the circumferential direction C) that is greater than that at an outer end 282b thereof. Further, each inner rotor groove of the plurality of inner rotor grooves 280 is spaced circumferentially from adjacent inner rotor grooves at a first circumferential length L1, and each outer rotor groove of the plurality of outer rotor grooves 282 is spaced circumferentially from adjacent outer rotor grooves at a second circumferential length L2 that is less than the first circumferential length L1. Particularly, the second circumferential length L2 of the plurality of outer rotor grooves 282 is such that two adjacent outer rotor grooves of the plurality of outer rotor grooves 282 radially overlap with a single inner rotor groove of the plurality of inner rotor grooves 280. As will be discussed in greater detail below, in this way, the plurality of inner rotor grooves 280 can cause the insulation material 112 (FIG. 1) flowing from the inlet 132 of the refining assembly 140 of the material refining unit 120 (FIG. 2D) to move radially outward toward the plurality of outer rotor grooves 282 and then toward the outlet 134 during operation of the material refining unit 120.

A plurality of inner rotor edges 281 (FIGS. 11A and 11D) and a plurality of outer rotor edges 283 (FIGS. 11A and 11E) are formed by the plurality of inner rotor grooves 280 and the plurality of outer rotor grooves 282, respectively, of the rotor plate 202. The plurality of inner rotor edges 281 and the plurality of outer rotor edges 283 are disposed along the front surface 274 and can assist in decompressing the insulation material 112 as the insulation material 112 flows in the gap 170 and within the plurality of inner rotor grooves 280 and then through the plurality of outer rotor grooves 282.

Referring to FIGS. 11D and 11E, each inner rotor groove of the plurality of inner rotor grooves 280 of the rotor plate 202 has a first width W1 and a first depth D1, as measured circumferentially and axially, respectively. Similarly, each outer rotor groove of the plurality of outer rotor grooves 282 has a second width W2 and a second depth D2, as measured circumferentially and axially, respectively. In the illustrated embodiment, the first depth D1 of the plurality of inner rotor grooves 280 is substantially the same as the second depth D2 of the plurality of outer rotor grooves 282. Further, the first width W1 of the plurality of inner rotor grooves 280 is greater than the second width W2 of the plurality of outer rotor grooves 282.

In some embodiments, the first depth D1 of the plurality of inner rotor grooves 280 can be different (e.g., greater) than the second depth D2 of the plurality of outer rotor grooves 282. In some embodiments, the second width W2 of the plurality of outer rotor grooves 282 can be a percentage of the first width W1 of the plurality of inner rotor grooves 280 in a range of about 20% to about 80%, in a range of about 25% to about 60%, or in a range of about 30% to about 45%. In some embodiments, the second width W2 of the plurality of outer rotor grooves 282 can be less than 50% of the first width W1 of the plurality of inner rotor grooves 280. In some embodiments, the second width W2 of the plurality of outer rotor grooves 282 can be less than 35% of the first width W1 of the plurality of inner rotor grooves 280.

The rotor plate 202 of the rotor 166 may be formed of various materials. For example, in some embodiments, the rotor plate 202 may be formed of a metallic material, e.g., steel. In some embodiments, the rotor plate 202 may be formed of a metallic material that is hardened or case hardened. In some embodiments, the rotor plate 202 may be formed of a metallic material that is coated, e.g., anodized aluminum. In some embodiments, the rotor plate 202 may be formed of a composite material, e.g., a glass-reinforced composite material. In some embodiments, the rotor plate 202 is manufactured via a casting process.

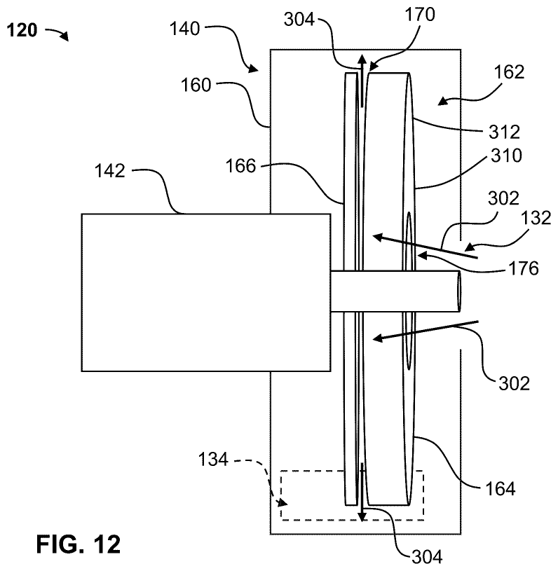

FIG. 12 is a schematic view of the material refining unit 120 of FIGS. 1 and 2A-2D. As shown in FIG. 12, as the insulation material 112 (FIG. 1) enters the internal cavity 162 of the housing 160 via the inlet 132, the insulation material 112 flows through the stator opening 176 (FIG. 7B) of the stator 164 and to the gap 170 between the stator 164 and the rotor 166, as schematically represented by arrows 302. The plurality of inner rotor grooves 280 of the rotor plate 202 (FIG. 11B) and an inner portion of the plurality of stator grooves 188 of the stator 164 (FIG. 7B) may define an inner refining zone 310. Likewise, the plurality of outer rotor grooves 282 of the rotor plate 202 (FIG. 11B) and an outer portion of the plurality of stator grooves 188 of the stator 164 may define an outer refining zone 312 that is radially outward relative to the inner refining zone 310. The plurality of vanes 206 (FIG. 8A) of the rotor 166 guides the insulation material 112 received at the stator opening 176 (via inlet 132 of the material refining unit 120) towards the inner refining zone 310.

As the insulation material 112 flows through the inner refining zone 310, the plurality of stator grooves 188 and the plurality of inner rotor grooves 280 guide flow of the insulation material 112 radially outward toward the outer refining zone 312, as schematically represented by arrows 304. The plurality of stator grooves 188 and the plurality of outer rotor grooves 282 then guide flow of the insulation material 112 toward the outlet 134 from the outer refining zone 312. Further, as the insulation material 112 flows radially outward from the stator opening 176 and through the inner refining zone 310 and the outer refining zone 312, the insulation material 112 is decompressed and declumped by the plurality of stator edges 189 of the stator 164 and the plurality of inner rotor edges 281 and the plurality of outer rotor edges 283 of the rotor plate 202 of the rotor 166.

The particular configuration of the material refining unit 120 may be beneficial to the design and operational performance of the material refining unit 120 or components thereof. Particularly, the inner refining zone 310 may refine the insulation material 112 (FIG. 1) having the first density (e.g., an initial density or a first intermediate density) to a fourth density (e.g., an intermediate density or a second intermediate density), and the outer refining zone 312 may further refine the insulation material 112 having the fourth density received from the inner refining zone 310 to the second density (e.g., a final density), which is less than the first density and the fourth density. In this way, torque provided by the motor 142 to adequately rotate the rotor 166 of the refining assembly 140 during operation of the material refining unit 120, and thus correspondingly a size of the motor 142, can be reduced, as compared to material installation systems without the benefit of the present disclosure. In some embodiments, the fourth density may be less than the first density and greater than the second density. In some embodiments, the third density may be less than the first density and greater than the second density, and the fourth density may be less than the third density and greater than the second density.

In some embodiments, a first density (e.g., an initial density or a packaged density) of the insulation material 112 (FIG. 1) may be in a range of about 8.0 lbs./ft.³ to about 18.0 lbs./ft.³ and a second density (e.g., a final density or an installation density) of the insulation material 112 (i.e., as the insulation material 112 exits the outlet 134 of the material refining unit 120) may be in a range of about 1.0 lb./ft.³ to about 4.0 lbs./ft.³. In some embodiments, the first density of the insulation material 112 may be in a range of about 12.5 lbs./ft.³ to about 18.0 lbs./ft.³ and the second density of the insulation material 112 may be in a range of about 1.5 lb./ft.³ to about 3.5 lbs./ft.³. In some embodiments, the first density of the insulation material 112 may be greater than about 14.0 lbs./ft.³ and the second density of the insulation material 112 may be less than about 4.0 lbs./ft.³. In some embodiments, the first density of the insulation material 112 may be greater than about 15.0 lbs./ft.³ and the second density of the insulation material 112 may be less than about 2.0 lbs./ft.³. In some embodiments, the material refining unit 120 may be configured to process or refine greater than about a thousand pounds of the insulation material 112 per hour. In some embodiments, the material refining unit 120 may be configured to process or refine greater than about two-thousand pounds of the insulation material 112 per hour. In some embodiments, the material refining unit 120 may be configured to process or refine greater than about four-thousand pounds of the insulation material 112 per hour.

In some embodiments, the material refining unit 120 may further include a vacuum source (not shown) in fluid communication with the internal cavity 162 of the housing 160. In such embodiments, the vacuum source can facilitate flow of the insulation material 112 through the internal cavity 162 of the housing 160 to the outlet 134. In some embodiments, the rotor 166 of the refining assembly 140 of the material refining unit 120 may further include a second plurality of vanes disposed along the rear surface 272 of the rotor plate 202 (FIG. 11C), opposite the plurality of vanes 206 (FIG. 8C). In such embodiments, the second plurality of vanes can facilitate flow of the insulation material 112 to the outlet 134 of the refining assembly 140.

Embodiments of the present disclosure provide for a material refining unit that can provide for installation of an insulation material, e.g., cellulose insulation, having a more uniform composition and a density that is substantially equal to a desired installation density of the insulation material, as compared to insulation material installation systems without the benefit of the present disclosure. Particularly, embodiments of the present disclosure can provide a material refining unit of a material installation system that adequately decompresses and declumps certain insulation materials, e.g., cellulose insulation, while having an overall weight and size that provides for the material refining unit to be utilized at a worksite of the material installation system. Thus, embodiments of the present disclosure can provide for installation of an insulation material, e.g., a cellulose insulation material, at a location with an increased coverage area per bale of insulation material, as compared to material installation systems without the benefit of the present disclosure. Moreover, embodiments of the present disclosure can permit an insulation material, e.g., a cellulose insulation material, to be compressed to a higher packaged density (e.g., in a range of about 12.5 lbs./ft.³ to about 18.0 lbs./ft.³), which can reduce costs for transportation of bulk insulation material.

Further aspects are provided by the subject matter of the following clauses.

A material refining unit for a material installation system includes a housing and a refining assembly. The housing defines an inlet, an outlet, and an internal cavity in fluid communication with the inlet and the outlet, the inlet being configured to receive an insulation material having a first density. The refining assembly is disposed within the internal cavity of the housing and defines a rotational axis, the refining assembly being configured to provide the insulation material having a second density at the outlet of the housing. The refining assembly includes a stator fixedly attached to the housing and a rotor rotatably coupled to the housing. The stator is axially aligned with the rotational axis and has a plurality of stator grooves. The rotor has a plurality of rotor grooves, the rotor being axially aligned with the rotational axis and disposed axially from the stator such that a gap is defined between the stator and the rotor.

The material refining unit of the preceding clause, wherein, during operation of the material refining unit, the rotor rotates with respect to the stator and guides the insulation material within the gap through the plurality of stator grooves and the plurality of rotor grooves radially outward relative to the rotational axis.

The material refining unit of any preceding clause, wherein the inlet is configured to be in fluid communication with a material transportation unit of the material installation system that provides the insulation material having the first density.

The material refining unit of any preceding clause, wherein the material refining unit further includes a motor operatively coupled to the rotor of the refining assembly to rotate the rotor about the rotational axis relative to the stator and to the housing.

The material refining unit of any preceding clause, wherein the rotor includes a rotor plate and a mounting base coupled to the rotor plate.

The material refining unit of any preceding clause, wherein the rotor further includes a plurality of vanes coupled to the rotor plate and to the mounting base.

The material refining unit of any preceding clause, wherein the mounting base and the plurality of vanes are removably coupled to the rotor plate.

The material refining unit of any preceding clause, wherein the material refining unit further includes a motor operatively coupled to the rotor of the refining assembly to rotate the rotor relative to the stator and to the housing, and wherein the mounting base is configured to operatively couple with the motor such that the rotor plate is operatively coupled with the motor via the mounting base.

The material refining unit of any preceding clause, wherein the plurality of rotor grooves is defined by the rotor plate and extend into a front surface of the rotor plate, the front surface of the rotor plate being substantially planar.

The material refining unit of any preceding clause, wherein a size of the gap is adjustable.

The material refining unit of any preceding clause, wherein the refining assembly further includes one or more shims arranged between to the stator and the housing, the size of the gap being adjustable via the one or more shims.

The material refining unit of any preceding clause, wherein the insulation material comprises cellulose.

The material refining unit of any preceding clause, wherein the plurality of rotor grooves comprises a plurality of inner rotor grooves and a plurality of outer rotor grooves, the plurality of outer rotor grooves being disposed radially outward from the plurality of inner rotor grooves relative to the rotational axis.

The material refining unit of any preceding clause, wherein an inner refining zone is defined by the plurality of inner rotor grooves and the plurality of stator grooves and an outer refining zone is defined by the plurality of outer rotor grooves and the plurality of stator grooves, the outer refining zone being disposed radially outward from the inner refining zone relative to the rotational axis.

The material refining unit of any preceding clause, wherein a width at an outer end of each inner rotor groove of the plurality of inner rotor grooves is greater than a width at an outer end of each outer rotor groove of the plurality of outer rotor grooves.

The material refining unit of any preceding clause, wherein the width at the outer end of each outer rotor groove of the plurality of outer rotor grooves is less than 50% of the width at the outer end of each inner rotor groove of the plurality of inner rotor grooves.

The material refining unit of any preceding clause, wherein a depth of each inner rotor groove of the plurality of inner rotor grooves is substantially the same as that of each outer rotor groove of the plurality of outer rotor grooves.

The material refining unit of any preceding clause, wherein a number of the plurality of inner rotor grooves is less than a number of the plurality of outer rotor grooves.

The material refining unit of any preceding clause, wherein a width of each stator groove of the plurality of stator grooves is constant along an entire radial length of each stator groove of the plurality of stator grooves.

The material refining unit of any preceding clause, wherein a depth of each stator groove of the plurality of stator grooves is constant along the entire radial length of each stator groove of the plurality of stator grooves.

The material refining unit of any preceding clause, wherein the stator has a stator opening extending through the stator and aligned with the rotational axis, the stator opening being adjacent to the inlet of the housing.

The material refining unit of any preceding clause, wherein the stator opening has a first portion that extends into a rear surface of the stator and a second portion that extends from the first portion to a front surface of the rotor.

The material refining unit of any preceding clause, wherein the first portion of the stator opening is generally cylindrical about the rotational axis and the second portion of the stator opening is conical and extends radially outward toward an outer surface of the stator from the first portion of the stator opening.

The material refining unit of any preceding clause, wherein the plurality of stator grooves extends continuously along the first portion and the second portion of the stator opening from the rear surface to the front surface and to the outer surface of the stator.

The material refining unit of any preceding clause, wherein the second density is different than the first density.

A material installation system includes a material refining unit and a material transportation unit. The material transportation unit includes an agitator and a blower. The material refining unit includes a housing and a refining assembly. The housing defines an inlet, an outlet, and an internal cavity in fluid communication with the inlet and the outlet, the inlet being configured to receive an insulation material having a first density. The refining assembly is disposed within the internal cavity of the housing and defines a rotational axis, the refining assembly being configured to provide the insulation material having a second density at the outlet of the housing. The refining assembly includes a stator fixedly attached to the housing and a rotor rotatably coupled to the housing. The stator is axially aligned with the rotational axis and has a plurality of stator grooves. The rotor has a plurality of rotor grooves, the rotor being axially aligned with the rotational axis and disposed axially from the stator such that a gap is defined between the stator and the rotor. The material refining unit is located downstream of the material transportation unit such that the material transportation unit provides the insulation material having the first density to the material refining unit via the blower that is in fluid communication with the inlet of the housing of the material refining unit.

The material installation system of the preceding clause, wherein the material installation system further includes an installation nozzle configured to apply the insulation material having the second density to a location, the installation nozzle being in fluid communication with the outlet of the housing of the material refining unit.

The material installation system of any preceding clause, wherein the agitator is configured to refine the insulation material from the first density to a third density that is less than the first density and greater than the second density, and the inlet of the material refining unit is configured to receive the insulation material having the first density or the third density.

A method for operating a material installation system to install an insulation material at a location. The method includes feeding the insulation material having a first density to a material transportation unit of the material installation system, blowing the insulation material from the material transportation unit to a material refining unit of the material installation system that is downstream of the material transportation unit, refining the insulation material to a second density via the material refining unit, and installing the insulation material having the second density from the material refining unit at the location.

The method of the preceding clause, wherein the method further includes, prior to blowing the insulation material to the material refining unit, refining the insulation material having the first density to a third density that is less than the first density and greater than the second density.

The method of any preceding clause, wherein the material transportation unit comprises a blower and an agitator.

The method of any preceding clause, wherein the material refining unit includes a refining assembly that comprises a rotor and a stator, and wherein refining the insulation material to the second density via the material refining unit includes rotating the rotor relative to the stator.

The method of any preceding clause, wherein the insulation material comprises cellulose.

The method of any preceding clause, wherein the first density is greater than the second density.

The method of any preceding clause, wherein the first density is in a range of about 8.0 pounds per cubic foot (lbs./ft.³) to about 18.0 lbs./ft.³, and the second density is in a range of about 1.0 lbs./ft.³ to about 4.0 lbs./ft.³.

The method of any preceding clause, wherein the material refining unit of the material installation system is configured to refine greater than about a thousand pounds of the insulation material per hour.

Although the foregoing description is directed to the preferred embodiments of the present disclosure, other variations and modifications will be apparent to those skilled in the art and may be made without departing from the disclosure. Moreover, features described in connection with one embodiment of the present disclosure may be used in conjunction with other embodiments, even if not explicitly stated above.

1. A material refining unit for a material installation system, the material refining unit comprising:
a housing defining an inlet, an outlet, and an internal cavity in fluid communication with the inlet and the outlet, the inlet being configured to receive an insulation material having a first density; and
a refining assembly disposed within the internal cavity of the housing and defining a rotational axis, the refining assembly being configured to provide the insulation material having a second density at the outlet of the housing, the refining assembly comprising:
a stator fixedly attached to the housing, the stator being axially aligned with the rotational axis and having a plurality of stator grooves; and
a rotor rotatably coupled to the housing and having a plurality of rotor grooves, the rotor being axially aligned with the rotational axis and disposed axially from the stator such that a gap is defined between the stator and the rotor.

2. The material refining unit of claim 1, wherein, during operation of the material refining unit, the rotor rotates with respect to the stator and guides the insulation material within the gap through the plurality of stator grooves and the plurality of rotor grooves radially outward relative to the rotational axis.

3. The material refining unit of claim 1, wherein the inlet is configured to be in fluid communication with a material transportation unit of the material installation system that provides the insulation material having the first density.

4. The material refining unit of claim 1, further comprising a motor operatively coupled to the rotor of the refining assembly to rotate the rotor about the rotational axis relative to the stator and to the housing.

5. The material refining unit of claim 1, wherein the second density is different than the first density.

6. The material refining unit of claim 1, wherein the insulation material comprises cellulose.

7. The material refining unit of claim 1, wherein a size of the gap is adjustable.

8. The material refining unit of claim 7, wherein the refining assembly further comprises one or more shims arranged between to the stator and the housing, the size of the gap being adjustable via the one or more shims.

9. The material refining unit of claim 1, wherein a width of each stator groove of the plurality of stator grooves is constant along an entire radial length of each stator groove of the plurality of stator grooves.

10. The material refining unit of claim 9, wherein a depth of each stator groove of the plurality of stator grooves is constant along the entire radial length of each stator groove of the plurality of stator grooves.

11. The material refining unit of claim 1, wherein the rotor comprises a rotor plate and a mounting base coupled to the rotor plate.

12. The material refining unit of claim 11, wherein the rotor further comprises a plurality of vanes coupled to the rotor plate and to the mounting base.

13. The material refining unit of claim 12, wherein the mounting base and the plurality of vanes are removably coupled to the rotor plate.

14. The material refining unit of claim 11, further comprising a motor operatively coupled to the rotor of the refining assembly to rotate the rotor relative to the stator and to the housing, and
wherein the mounting base is configured to operatively couple with the motor such that the rotor plate is operatively coupled with the motor via the mounting base.

15. The material refining unit of claim 11, wherein the plurality of rotor grooves is defined by the rotor plate and extend into a front surface of the rotor plate, the front surface of the rotor plate being substantially planar.

16. The material refining unit of claim 1, wherein the plurality of rotor grooves comprises a plurality of inner rotor grooves and a plurality of outer rotor grooves, the plurality of outer rotor grooves being disposed radially outward from the plurality of inner rotor grooves relative to the rotational axis.

17. The material refining unit of claim 16, wherein an inner refining zone is defined by the plurality of inner rotor grooves and the plurality of stator grooves and an outer refining zone is defined by the plurality of outer rotor grooves and the plurality of stator grooves, the outer refining zone being disposed radially outward from the inner refining zone relative to the rotational axis.

18. The material refining unit of claim 16, wherein a number of the plurality of inner rotor grooves is less than a number of the plurality of outer rotor grooves.

19. The material refining unit of claim 16, wherein a width at an outer end of each inner rotor groove of the plurality of inner rotor grooves is greater than a width at an outer end of each outer rotor groove of the plurality of outer rotor grooves.

20. The material refining unit of claim 19, wherein the width at the outer end of each outer rotor groove of the plurality of outer rotor grooves is less than 50% of the width at the outer end of each inner rotor groove of the plurality of inner rotor grooves.

21. The material refining unit of claim 20, wherein a depth of each inner rotor groove of the plurality of inner rotor grooves is substantially the same as that of each outer rotor groove of the plurality of outer rotor grooves.

22. The material refining unit of claim 1, wherein the stator has a stator opening extending through the stator and aligned with the rotational axis, the stator opening being adjacent to the inlet of the housing.

23. The material refining unit of claim 22, wherein the stator opening has a first portion that extends into a rear surface of the stator and a second portion that extends from the first portion to a front surface of the rotor.

24. The material refining unit of claim 23, wherein the first portion of the stator opening is generally cylindrical about the rotational axis and the second portion of the stator opening is conical and extends radially outward toward an outer surface of the stator from the first portion of the stator opening.

25. The material refining unit of claim 24, wherein the plurality of stator grooves extends continuously along the first portion and the second portion of the stator opening from the rear surface to the front surface and to the outer surface of the stator.

26. A material installation system, comprising:
the material refining unit of claim 1; and
a material transportation unit comprising an agitator and a blower,
wherein the material refining unit is located downstream of the material transportation unit such that the material transportation unit provides the insulation material having the first density to the material refining unit via the blower that is in fluid communication with the inlet of the housing of the material refining unit.

27. The material installation system of claim 26, further comprising an installation nozzle configured to apply the insulation material having the second density to a location, the installation nozzle being in fluid communication with the outlet of the housing of the material refining unit.

28. The material installation system of claim 26, wherein the agitator is configured to refine the insulation material from the first density to a third density, the third density being less than the first density and greater than the second density, and
wherein the inlet of the material refining unit is configured to receive the insulation material having the first density or the third density.

29. A method for operating a material installation system to install an insulation material at a location, the method comprising:
feeding the insulation material having a first density to a material transportation unit of the material installation system;
blowing the insulation material from the material transportation unit to a material refining unit of the material installation system that is downstream of the material transportation unit;
refining the insulation material to a second density via the material refining unit; and
installing the insulation material having the second density from the material refining unit at the location.

30. The method of claim 29, wherein the material refining unit includes a refining assembly that comprises a rotor and a stator, and
wherein refining the insulation material to the second density via the material refining unit includes rotating the rotor relative to the stator.

31. The method of claim 29, wherein the insulation material comprises cellulose.

32. The method of claim 29, wherein the material refining unit of the material installation system is configured to refine greater than about a thousand pounds of the insulation material per hour.

33. The method of claim 29, further comprising, prior to blowing the insulation material to the material refining unit:
refining the insulation material having the first density to a third density, the third density being less than the first density and greater than the second density.

34. The method of claim 33, wherein the material transportation unit comprises a blower and an agitator.

35. The method of claim 29, wherein the first density is greater than the second density.

36. The method of claim 35, wherein the first density is in a range of about 8.0 pounds per cubic foot (lbs./ft.³) to about 18.0 lbs./ft.³, and the second density is in a range of about 1.0 lbs./ft.³ to about 4.0 lbs./ft.³.
